(19) United States
(12) Patent Application Publication
(10) Pub. No.: US 2024/0419312 A1
(43) Pub. Date: Dec. 19, 2024

(54) PAGE DISPLAY METHOD AND APPARATUS, ELECTRONIC DEVICE, AND STORAGE MEDIUM

(71) Applicant: BEIJING YOUZHUJU NETWORK TECHNOLOGY CO., LTD., Pinggu District, Beijing (CN)

(72) Inventors: Qinyuan ZHANG, Beijing (CN); Ting ZHOU, Beijing (CN); Liangcheng XU, Beijing (CN)

(21) Appl. No.: 18/706,140

(22) PCT Filed: Nov. 4, 2022
(86) PCT No.: PCT/CN2022/129894

§ 371 Date: Apr. 30, 2024

(30) Foreign Application Priority Data
Nov. 5, 2021 (CN) 202111306836.0

(51) Int. Cl. G06F 3/04845

(52) U.S. Cl. CPC G06F 3/04845

(57) ABSTRACT

A page display method and apparatus, an electronic device, a storage medium, and a program product are provided, and the page display method includes: displaying a page overlay about a target object on a first media display page, in which the page overlay covers at least a portion of a region of the first media display page, the page overlay includes an object display region for displaying the target object and an information display region for displaying first associated information about the target object, and the object display region has a first display size; and changing the object display region of the page overlay from the first display size to a second display size in response to a first operation instruction for the page overlay. The page display method can make the display form of detailed information more convenient.

### CROSS-REFERENCE TO RELATED APPLICATION

The present application claims the priority to Chinese Patent Application No. 202111306836.0, filed on Nov. 5, 2021, the entire disclosure of which is incorporated herein by reference as portion of the present application.

### TECHNICAL FIELD

Embodiments of the present disclosure relate to a page display method and apparatus, an electronic device, a storage medium, and a computer program product.

### BACKGROUND

With the development of network and computer technology, media forms have become more diversified. Media forms such as online live streaming and short videos, which have emerged in recent years, are increasingly integrated into people's lives. For example, some users can introduce and recommend items to other users through media formats like online live streaming, and can push item links. Other users can click on these item links to jump from the media page to the corresponding item detail page for viewing.

### SUMMARY

At least one embodiment of the present disclosure provides a page display method and apparatus, an electronic device, and a storage medium, which can make the display form of detail information more novel and diversified, and can enhance the interactive experience.

At least one embodiment of the present disclosure provides a page display method, including: displaying a page overlay about a target object on a first media display page, in which the page overlay covers at least a portion of a region of the first media display page, the page overlay includes an object display region for displaying the target object and an information display region for displaying first associated information about the target object, and the object display region has a first display size; and changing the object display region of the page overlay from the first display size to a second display size in response to a first operation instruction for the page overlay.

At least one embodiment of the present disclosure provides a page display apparatus, including a first display module and a second display module; the first display module is configured to display a page overlay about a target object on a first media display page, the page overlay covers at least a portion of a predetermined page, and the page overlay includes an object display region for displaying the target object and an information display region for displaying first associated information about the target object; and the second display module is configured to change the object display region of the page overlay from a first display size to a second display size in response to a first operation instruction for the page overlay.

At least one embodiment of the present disclosure provides an electronic device, which includes a processor and a memory including one or more computer program modules; the one or more computer program modules are stored in the memory and configured to be executed by the processor, and the one or more computer program modules include instructions for implementing the page display method according to any one of the embodiments of the present disclosure.

At least one embodiment of the present disclosure provides a storage medium, configured to non-transitorily store computer-readable instructions, and the computer-readable instructions, when executed by a computer, implement the page display method according to any one of the embodiments of the present disclosure.

At least one embodiment of the present disclosure provides a computer program product, including a computer program carried on a non-transitory computer-readable medium, and the computer program includes program code for executing the page display method according to any one of the embodiments of the present disclosure.

### BRIEF DESCRIPTION OF DRAWINGS

The foregoing and other features, advantages, and aspects of the embodiments of the present disclosure may become more apparent in conjunction with the drawings and with reference to the following detailed description. Throughout the drawings, the same reference numerals indicate the same elements. It should be understood that the drawings are schematic, and components and elements are not necessarily drawn to scale.

FIG. 1 illustrates a schematic flow diagram of a page display method provided by some embodiments of the present disclosure;

FIG. 2 illustrates a schematic diagram of a first media display page provided by some embodiments of the present disclosure;

FIG. 3 illustrates a schematic diagram of a page overlay provided by some embodiments of the present disclosure;

FIG. 4 illustrates a schematic diagram of a changed page overlay provided by some embodiments of the present disclosure;

FIG. 5 illustrates a schematic diagram of a page overlay during a change process provided by some embodiments of the present disclosure;

FIG. 6 illustrates a system that may be configured to execute a page display method provided by the embodiments of the present disclosure;

FIG. 7 illustrates a schematic block diagram of a page display apparatus provided by some embodiments of the present disclosure;

FIG. 8 illustrates a schematic block diagram of an electronic device provided by some embodiments of the present disclosure;

FIG. 9 illustrates a schematic block diagram of another electronic device provided by some embodiments of the present disclosure; and

FIG. 10 illustrates a schematic diagram of a storage medium provided by some embodiments of the present disclosure.

### DETAILED DESCRIPTION

Embodiments of the present disclosure will be described in more detail below with reference to the drawings. While certain embodiments of the present disclosure are shown in the drawings, it should be understood that the present disclosure may be embodied in various forms and should not be construed as limited to the embodiments set forth herein. Rather, these embodiments are provided for a thorough and complete understanding of the present disclosure. It should be understood that the drawings and embodiments of the present disclosure are only for exemplary purposes and are not intended to limit the protection scope of the present disclosure.

It should be understood that the various steps described in the method embodiments of the present disclosure may be performed in different orders and/or in parallel. Furthermore, the method embodiments may include additional steps and/or omit performing the illustrated steps. The protection scope of the present disclosure is not limited in this aspect.

As used herein, the term “include,” “comprise,” and variations thereof are open-ended inclusions, i.e., “including but not limited to.” The term “based on” is “based, at least in part, on.” The term “an embodiment” represents “at least one embodiment,” the term “another embodiment” represents “at least one additional embodiment,” and the term “some embodiments” represents “at least some embodiments.” Relevant definitions of other terms will be given in the description below.

It should be noted that concepts such as the “first,” “second,” or the like mentioned in the present disclosure are only used to distinguish different devices, modules or units, and are not to limit the interdependence relationship or the order of functions performed by these devices, modules or units.

It should be noted that the modifications of “a,” “an,” “a plurality of,” or the like mentioned in the present disclosure are illustrative rather than restrictive, and those skilled in the art should understand that unless the context clearly indicates otherwise, these modifications should be understood as “one or more.” “a plurality of” should be understood as two or more.

The names of the messages or information exchanged between a plurality of apparatuses in the embodiments of the present disclosure are for illustrative purposes only and are not intended to limit the scope of these messages or information.

Clicking on item links in live streaming pages, short video pages, and other video play pages will directly redirect to the corresponding item detail pages. If users wish to continue watching the video, they need to click a back button to return to the video play page. This form of displaying the item detail page is relatively monotonous, and the user's interactive experience is poor and inconvenient, and on the other hand, it also interrupts the user's viewing of the video, and cannot well combine the video play page with the item detail page, which affects the user experience.

Hereinafter, the embodiments of the present disclosure are described in detail with reference to the drawings.

FIG. 1 illustrates a schematic flow diagram of a page display method provided by some embodiments of the present disclosure. As shown in FIG. 1, in at least one embodiment, the method includes steps S110 and S120.

Step S110: displaying a page overlay about a target object on a first media display page, in which the page overlay covers at least a portion of a region of the first media display page, the page overlay includes an object display region for displaying the target object and an information display region for displaying first associated information about the target object, and the object display region has a first display size.

Step S120: changing the object display region of the page overlay from the first display size to a second display size in response to a first operation instruction for the page overlay.

For example, the target object may include at least one of objects such as an item, a person, an animal, etc., the associated information (e.g., the first associated information and the second associated information in the following) may be descriptive information about the target object, and the associated information may be presented in the form of characters, such as text, numerals, letters of the alphabet, etc. In some examples, in the case where the target object is an item (e.g., a commodity, an exhibit, etc.), the associated information may include detailed information about the item, such as including at least one of a name, a price, a sales volume, a parameter, an evaluation, an explanatory note, and the like of the item. In some of the following embodiments, the target object is an item as an example for illustration, but the embodiments of the present disclosure are not limited thereto, and the type of the target object may be set according to the actual requirements in the process of practical application.

For example, in some examples, the first media display page may be a video play page, and the video played on the video play page is a video corresponding to the target object. For example, the video corresponding to the target object may be understood as one or multiple frames of images of the video displaying the target object, or the target object is an explanatory object of the video, or the like. For example, the first media display page may be a live streaming page, a short video page, a long video page, and other pages that play video-type media resources, or may be, for example, an animated frame such as a GIF. In some other examples, the first media display page may also be other dynamic or static pages, such as a news page, a chat page, and the like. In some of the following embodiments, the first media display page is a live streaming page as an example of illustration.

For example, the first media display page may display a link about the target object, such as an advertisement link, a product recommendation link, etc. about the target object. In the case where the link about the target object is subjected to an operation such as click, double-click, and the like, the page display method provided by the embodiments of the present disclosure may be executed.

For example, the page display method provided by the embodiments of the present disclosure may be executed by a terminal device, and the terminal device includes but is not limited to a mobile phone, a tablet computer, a laptop computer, and the like. The terminal device may include a display screen, a processor, a data transceiver device, and the like, and the terminal device may transmit data with a server and/or a database through a communication network.

For example, in step S110, the page overlay about the target object is displayed on the first media display page, it may be understood that the page overlay is located on a side of the first media display page facing the user, i.e., the page overlay is located on a layer above the layer on which the first media display page is located, and the visual effect presented is that the page overlay covers the first media display page. In some examples, the overlay may be understood as a floating layer, a covering layer, and the like.

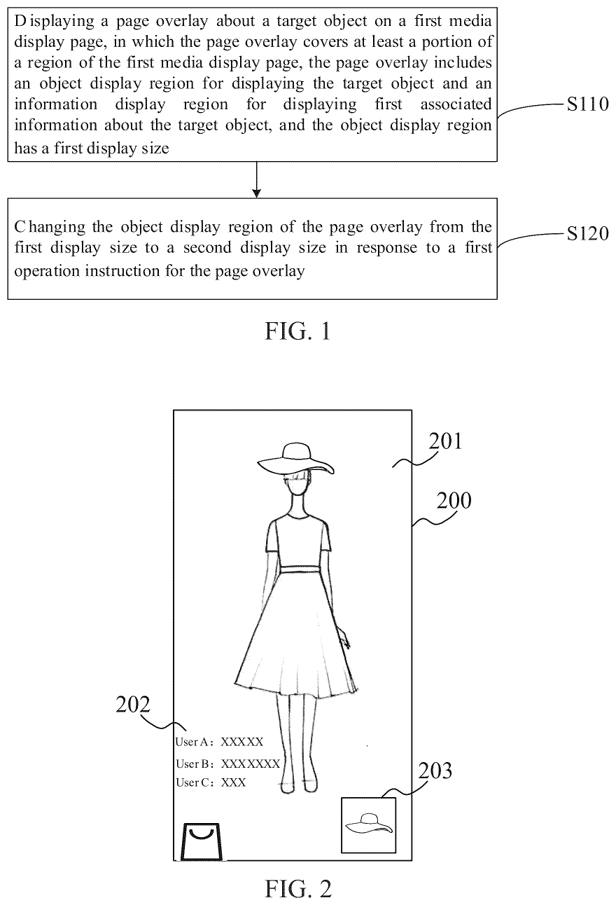

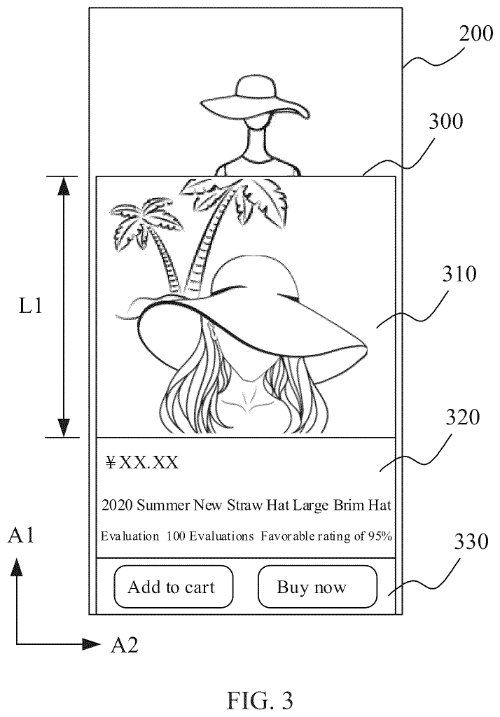

FIG. 2 illustrates a schematic diagram of a first media display page provided by some embodiments of the present disclosure. FIG. 3 illustrates a schematic diagram of a page overlay provided by some embodiments of the present disclosure.

As shown in FIG. 2 and FIG. 3, in some examples, the first media display page 200 may be a live streaming page (e.g., a live streaming room page), through which a live streaming user can deliver information, such as images and sounds in real time to a user who is watching the live streaming, and the user who is watching the live streaming can interact with the live streaming user in real time by posting a comment, etc., on the live streaming page. The live streaming page includes a live streaming video 201, a user comment 202, an item link 203, and other contents. Each item link 203 may be linked to a page overlay corresponding to the item, so as to display detailed information about the item through the page overlay. For example, the target object is an item “hat”, and if the item link 203 is clicked, double-clicked, or the like, the page overlay 300 about the hat may be displayed on the live streaming page 200, and the page overlay 300 may partially or completely cover the first media display page 200. The first media display page 200 may continue to play the video if the page overlay about the target object is displayed on the first media display page.

For example, in step S110, the object display region 310 has the first display size, and the display size of the object display region 310 may include a size in a first direction A1 and/or a size in a second direction A2, where the first direction A1 may be a longitudinal direction or a length direction of the page, and the second direction A2 may be a direction perpendicular to the first direction A1, for example, a horizontal direction or a width direction of the page.

For example, the page overlay 300 includes an object display region 310 for displaying the target object and an information display region 320 for displaying the first associated information about the target object. The object display region 310 is configured to display a picture of the target object, and if the target object is the “hat”, for example, the object display region 310 may display a picture of the hat. The object display region 310 has the first display size, and the first display size may be smaller than the display size of the first media display page 300. For example, the information display region 320 is located on a side of the object display region 310 close to a bottom edge of the page overlay 300, and the information display region 320 may display information entries such as a product name, a price, and an evaluation, etc. about the hat.

For example, in step S120, the first operation instruction may be generated by an interaction event, and the interaction event may be a touch operation for the page overlay 300. For example, performing a predetermined touch operation on the page overlay 300 may trigger the first operation instruction, and the predetermined touch operation may be a sliding operation (such as a slide-up operation, a multi-touch operation, and the like), a click operation, a double-click operation, etc., and the present embodiments of the disclosure do not impose any limitation on the specific form of the touch operation. For example, the first operation instruction is an instruction that can cause the page overlay 300 to undergo an interface change, and the interface change includes changing the object display region 310 from the first display size to the second display size.

According to the page display method of the embodiments of the present disclosure, the page overlay about the target object may be displayed on the media display page, such as a live streaming page, to display detailed information about the target object in the form of an overlay, and the problem of video interruption due to page jumps in the related technologies may be avoided. Moreover, based on the page display method, the size of the page overlay may be changed by a touch operation, which may display the detailed information more conveniently, make the display form of the detailed information more novel and diversified, and enhance the interactive experience.

For example, the page display method of the embodiments of the present disclosure may further include: replacing the first associated information in the information display region 320 of the page overlay with second associated information, during changing the object display region 310 of the page overlay from the first display size to the second display size. Based on this method, changing the information in the information display region while changing the size of the object display region allows for displaying richer detail information and enhancing the interactive experience.

For example, in some examples, the first display size is smaller than the second display size, i.e., in response to the first operation instruction, the display area of the object display region 310 is increased. The display area of the information display region 320 may be increased or remain unchanged.

For example, as shown in FIG. 3, in step S110, the page overlay 300 may cover a portion of the region of the first media display page 200. For example, the page overlay 300 may be disposed in a bottom region of the first media display page 200, a bottom side (bottom edge) of the page overlay 300 may be aligned with a bottom side of the first media display page 200, a top side (top edge) of the page overlay 300 has a certain distance from a top side of the first media display page 200, and left and right sides (left and right edges) of the page overlay 300 may be aligned with or have a distance from the left and right sides of the first media display page 200, respectively. In other examples, the page overlay 300 may also be in a top region or other region of the first media display page 200.

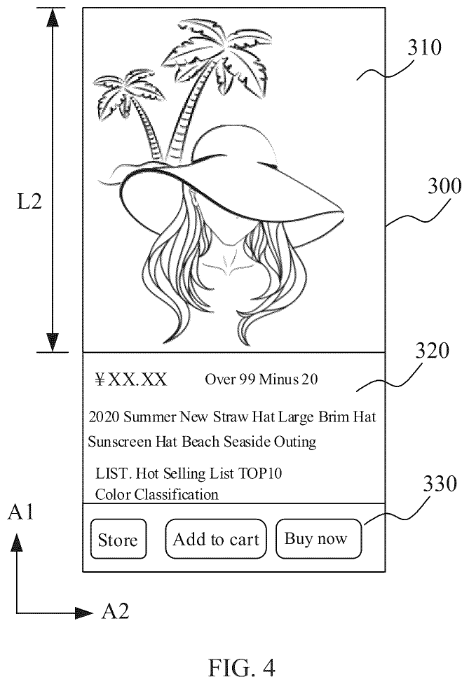

FIG. 4 illustrates a schematic diagram of a changed page overlay provided by some embodiments of the present disclosure. As shown in FIG. 3 and FIG. 4, in response to the first operation instruction, the display area of the object display region 310 of the page overlay increases. For example, the first display size includes a length size L1, the second display size includes a length size L2, and L2>L1, i.e., the length of the object display region 310 increases. For example, during the change process, the top side of the object display region 310 is moved upward to close to the top side of the first media display page 200 or to be aligned with the top side of the first media display page 200, the bottom side of the object display region 310 may be moved toward the top side but by a distance that is less than the distance that the top side is moved, or the bottom side of the object display region 310 may not be moved, or the bottom side of the object display region 310 may be moved in a direction away from the top side, as long as it is ensured that the distance between the top side of the object display region 310 and the bottom side of the object display region 310 increases. In response to the first operation instruction, the size of the page overlay 300 in the width direction may remain unchanged, or the size of the page overlay 300 in the width direction may increase.

For example, as shown in FIG. 4, if the object display region 310 of the page overlay has the second display size, the page overlay 300 may completely cover the first media display page. In this way, in response to the first operation instruction, the page overlay 300 may be converted from a non-full-screen display to a full-screen display to maximize the detailed information of the target object. Moreover, the existing way to view the item details from the video play page such as a live streaming room page generally includes first clicking on the shopping cart icon in the live streaming room page to enter the item details list, selecting and clicking on an item from the item details list and then entering the item details page. The display mode of the item details page is fixed, and the interaction mode is monotonous, which is not able to meet the user requirements. The page display method of the embodiments of the present disclosure can quickly and conveniently realize the switching of the target object from partial display to complete display by a sliding operation and other interactive methods, which is convenient for users to understand the details of the object and quickly return to the video play page.

For example, in some other embodiments, if the object display region 310 of the page overlay has the second display size, the page overlay 300 may also partially cover the first media display page.

For example, in some other examples, the first display size may be larger than the second display size, i.e., in response to the first operation instruction, the display area of the object display region 310 is decreased. The display area of the information display region 320 may be decreased or unchanged. The object display region thus has the first display size at initial time, which is convenient for the user to view the object information while conveniently returning to play the video, and in response to the first operation instruction for the page overlay, the object display region of the page overlay is changed from the first display size to the second display size, which satisfies the user's requirement to view more information about the object, and conforms to the user's expectation.

For example, in step S110, the object display region 310 may have the size L2 as shown in FIG. 4. In step S120, in response to the first operation instruction, the length of the object display region 310 is reduced from the size L2 to the size L1 shown in FIG. 3. For example, in step S110, the page overlay 300 may cover the entire region of the first media display page 200. In step S120, in response to the first operation instruction, the page overlay 300 is converted from the full-screen display to the non-full-screen display. Specifically, the example in which the first display size is larger than the second display size may adopt an opposite scheme to the above example in which the first display size is smaller than the second display size, which is not repeated here. The following examples are illustrated with the first display size is smaller than the second display size.

For example, after an interface change of the page overlay 300 occurs in response to the first operation instruction, the first media display page 200 may continue to play the video or may pause the video. For example, whether or not the first media display page 200 continues to play the video may be determined based on a percentage of the page overlay 300 covering the first media display page 200. In the case where the percentage of coverage is less than a predetermined percentage (e.g., 80% or 100%), the first media display page 200 may continue to play the video, and in the case where the percentage of coverage is greater than or equal to the predetermined percentage, the first media display page 200 may pause the video. For example, after the first media display page 200 pauses the video, the video may be displayed as a floating window on the page overlay 300 to enable the user to continue watching the video.

For example, the second associated information is not exactly identical but may be partially identical to the first associated information, for example, the first associated information may be a portion of the second associated information. The second associated information includes P entry information, and the P entry information may include name information, price information, sales volume information, parameter information, evaluation information, list information, guarantee information, explanatory note information, and the like. The first associated information may include Q key entry information among the P entry information (P is a positive integer, and Q is a positive integer less than P), and the Q key entry information may include name information, price information, rating information, and the like.

For example, in the page overlay 300 shown in FIG. 4, the information display region 320 is a slidable viewing region, i.e., more content may be displayed by performing a sliding operation on the information display region 320.

For example, the size of the object display region of the page overlay and the associated information displayed in the information display region may be gradually changed. For example, if the touch operation is a non-continuous operation, such as a click, a double-click, etc., the change process may be completed within a predetermined length of time (e.g., 1 second) after the touch operation, and within the predetermined length of time, the page overlay gradually changes. If the touch operation is a continuous operation, such as the sliding operation, the change process may be gradual with the operation, for example, the page overlay gradually changes as the sliding operation proceeds.

For example, the step S120 may include: gradually changing the object display region 310 of the page overlay from the first display size to the second display size. The edges of the object display region gradually expand outwardly during the size change process of the object display region, for example, the top side of the object display region gradually expands upwardly to present the effect of gradually expanding and enlarging.

For example, as shown in FIG. 4, if the object display region 310 has the second display size, the object display region 310 displays all the image region of a picture about the target object (hereinafter also referred to as an object picture), i.e., the object picture may be displayed completely. As shown in FIG. 3, if the object display region 310 of the page overlay has the first display size, the object display region 310 displays a portion of the image region (hereinafter the portion of the image region is referred to as a sub-image) of the picture about the target object, i.e., the object picture is partially displayed. For example, the object picture is a long picture, and the sub-image is a square picture.

For example, the picture about the target object may include the target object, and may also include an associated object related to the target object. For example, as shown in FIG. 3, the target object is a hat, and the associated object may be a person wearing the hat, or a scene or background in which the hat is located (e.g., the background of the hat in FIG. 3 is a coconut tree).

For example, in some examples, if the object display region 310 has the second display size, the entire region of the target object is displayed, such as the entire region of the hat is displayed in the object display region. If the object display region 310 has the first display size, the partial region of the target object is displayed, such as the partial region of the hat is displayed in the object display region. That is, during the process of converting the object display region 310 from the first display size to the second display size, the target object in the object display region is changed from being partially displayed to entirely displayed.

For example, in some examples, where the object display region 310 has the second display size, the entire region of the associated object is displayed, such as the entire region of the coconut tree is displayed in the object display region. If the object display region 310 has the first display size, the partial region of the associated object is displayed, such as the partial region of the coconut tree is displayed in the object display region. That is, during the process of converting the object display region 310 from the first display size to the second display size, the associated object in the object display region is changed from being partially displayed to entirely displayed.

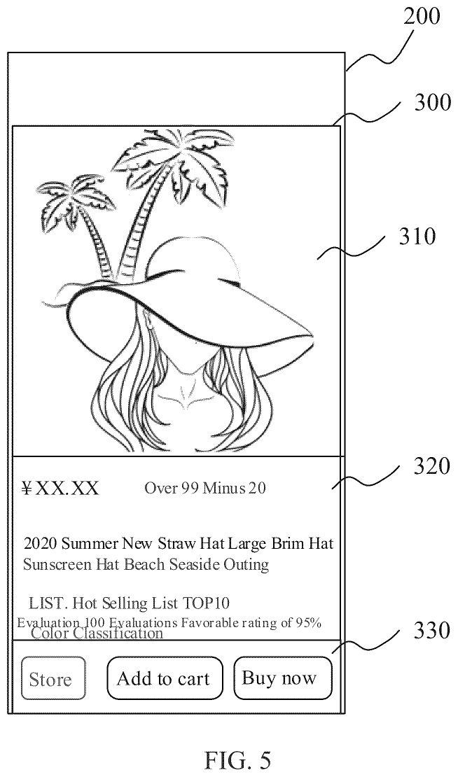

FIG. 5 illustrates a schematic diagram of a page overlay during the change process provided by some embodiments of the present disclosure.

As shown in FIG. 3, FIG. 4, and FIG. 5, during the process of changing the object display region 310 from the first display size shown in FIG. 3 to the second display size shown in FIG. 4, the remaining image region of the object picture is gradually expanded out from at least one edge of the sub-image (e.g., the top edge and the bottom edge) until the entire region of the object picture may be presented after changing to the second display size.

For example, in some examples, the sub-image is obtained by cropping the region where the target object is located from the object picture. For example, the object picture may be recognized based on an object recognition model to identify the location where the target object is located, and the sub-image is cropped with the target object's center as the center, taking an image region of the first display size. The object recognition model may be obtained in advance based on sample data training, and the object recognition model may be, for example, a neural network model, a deep learning model, a classification tree model, and the like. In this way, the display effect of the target object in the object display region can be ensured.

For example, in other examples, the sub-image is obtained by cropping a predetermined region of the object picture. For example, the sub-image is cropped with the center of the object picture as the center, taking an image region of the first display size.

For example, in other examples, the sub-image is obtained by cropping a region indicated by marking information from the object picture. For example, region marking may be performed on the object picture in advance to mark the region that may be cropped, and when the sub-image needs to be acquired, the corresponding image region is cropped as the sub-image based on the marking information.

For example, the step S120 may include: visually gradually replacing the first associated information in the information display region of the page overlay with the second associated information. For example, the first associated information gradually disappears and the second associated information gradually becomes visible.

For example, as shown in FIG. 5, in one example, the display color of the first associated information gradually changes to a color that is the same as the background, for example, if the background is white, the first associated information changes from dark to light until it becomes white. The display color of the second associated information gradually changes to a color different from the background, for example, if the background is white, the second associated information changes from light to dark until it becomes black. If there is the same information in the first associated information and the second associated information, the display color of the same information may not change, and the display color of the information other than the same information in the first associated information and the second associated information gradually changes.

For example, in one example, the first associated information gradually becomes smaller and the second associated information gradually becomes larger. For example, the text in the first associated information gradually becomes smaller from a conventional size until it disappears, and the text in the second associated information gradually becomes larger to the conventional size.

For example, in one example, the first associated information gradually decreases, and the second associated information gradually increases. For example, the text in the first associated information disappears line by line or column by column, and the text in the second associated information appears line by line or column by column, so that the second associated information replaces the first associated information line by line or column by column.

For example, the change mode between the first associated information and the second associated information may also adopt other change modes, such as sliding out and sliding in, page flipping, etc.

For example, the first associated information includes multiple sub-associated information, and as shown in FIG. 3, the first associated information may include multiple sub-associated information such as price information, name information, evaluation information, and the like. The first associated information includes first sub-associated information, and the first sub-associated information may be price information, name information, or evaluation information, etc. If the object display region 310 of the page overlay has the first display size, the information display region 320 displays a part of the first sub-associated information, i.e., the first sub-associated information is partially displayed. If the object display region of the page overlay has the second display size, the information display region 320 displays all the first sub-associated information, i.e., the first sub-associated information is fully displayed. For example, the full name of the name information is “2020 Summer New Straw Hat Large Brim Hat Sun Hat Sunscreen Hat Beach Seaside Outing”, as shown in FIG. 3, if the object display region 310 has the first display size, the name item is only displayed with some characters “2020 Summer New Straw Hat Large Brim Hat”. As shown in FIG. 4, if the object display region 310 has the second display size, the name item may be displayed in its entirety. In this way, the page overlay, when in a small size, displays a part of the sub-associated information, which can save display space without affecting viewing. When the area of the page overlay is expanded, it displays all the sub-associated information, allowing users to gain a more comprehensive and detailed understanding of the target object.

For example, as shown in FIG. 3, FIG. 4, and FIG. 5, the page overlay 300 further includes a control accommodation region 330 for accommodating at least one page control. The page display method of the present embodiment may further include: replacing a first control in the control accommodation region 330 of the page overlay with a second control, during changing the object display region 310 of the page overlay 300 from the first display size to the second display size, in which the first control is different from the second control.

For example, the first control and the second control are not identical but may be partially identical. The second control may include E controls, and the E controls may include an “add to cart” control, a “buy now” control, a “store” control, a “customer service” control, etc. The first control may be F key controls among the E controls, and the F key controls are, for example, the “add to cart” control and the “buy now” control. E is a positive integer and F is a positive integer less than E.

For example, replacing the first control in the control accommodation region of the page overlay with the second control may includes visually gradually replacing the first control in the control accommodation region of the page overlay with the second control.

For example, the first control gradually disappears and the second control gradually becomes visible. Specifically, the change mode between the first control and the second control may refer to the change mode between the first associated information and the second associated information, which is not repeated here.

The page display method of the embodiments of the present disclosure may change the controls in the page overlay through touch operations, making the display form of the detail information more novel and diversified, and enhancing the interactive experience.

It should be noted that in the embodiments of the present disclosure, the execution order of the respective steps of the page display method is not limited, and although the execution process of the respective steps is described above in a particular order, this does not constitute the limitation on the embodiments of the present disclosure. The respective steps in the page display method may be executed serially or in parallel, which may be based on actual requirements. The page display method may also include more or fewer steps, for example, adding some preprocessing steps to achieve a better display effect, or storing data from some intermediate processes for use in subsequent processing and calculations to omit some similar steps.

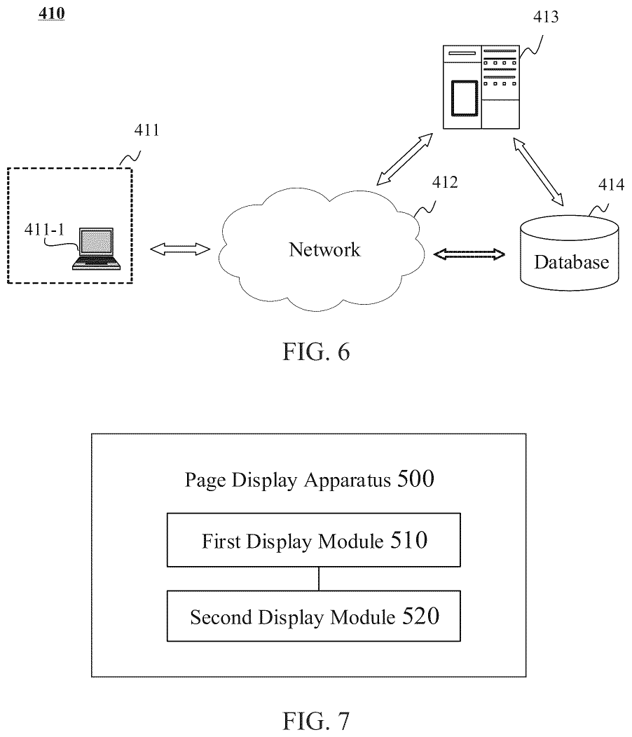

FIG. 6 illustrates a system that may be configured to execute a page display method provided by the embodiments of the present disclosure. As shown in FIG. 6, system 410 may include a user terminal 411, a network 412, a server 413, and a database 414. For example, the system 410 may be configured to implement the page display method provided by any one of the embodiments of the present disclosure.

The user terminal 411 is, for example, a computer 411-1. It may be understood that the user terminal 411 may be any other type of electronic device capable of performing data processing, which may include, but is not limited to, a desktop computer, a laptop computer, a tablet computer, a workstation, and the like. The user terminal 411 may also be any equipment provided with the electronic device. The embodiments of the present disclosure do not impose any limitation on the hardware configuration or software configuration (e.g., the type (e.g., Android, iOS, Windows, MacOS, HarmonyOS, etc.) or version of an operating system), etc., of the user terminal.

The user may operate the application program installed on the user terminal 411 or the website logged in on the user terminal 411, the application program or the website transmits the user operation to the server 413 through the network 412, and the user terminal 411 may further receive data transmitted by the server 413 through the network 412.

For example, the user terminal 411 is installed with a video play software, and the user may utilize the video play software on the user terminal 411 to view the first media display page. When it is necessary to view the detailed information of the target object, the user terminal 411 executes the page display method provided by the embodiments of the present disclosure by running code.

The network 412 may be a single network, or a combination of at least two different networks. For example, the network 412 may include, but is not limited to, a combination of one or more of a local area network (LAN), a wide area network (WAN), a public network, a private network, etc.

The server 413 may be a single server, or a server cluster, and respective servers within the cluster are connected through a wired or wireless network. The server cluster may be centralized, such as a data center, or distributed. The servers 413 may be local or remote.

The database 414 may generally refer to any device with storage capability. The database 414 is primarily configured to store various data utilized, generated, and output by the user terminal 411 and the server 413 during operation. The database 414 may be local or remote. The database 414 may include various types of memory, such as random access memory (RAM), read only memory (ROM), etc. The storage devices mentioned above are just some examples, and the storage devices the system 410 can use are not limited to these.

The database 414 may be interconnected or in communication with the server 413 or a portion thereof through the network 412, or directly interconnected or in communication with the server 413, or a combination of the above two methods.

In some examples, the database 414 may be a standalone device. In other examples, the database 414 may also be integrated in at least one of the user terminal 411 and the server 413. For example, the database 414 may be provided in the user terminal 411 or in the server 413. For another example, the database 414 may also be distributed, with a portion provided in the user terminal 411 and another portion provided in the server 413.

For example, the video displayed on the first media display page, pictures and associated information about the target object, etc. may be deployed in the database 414. When it is necessary to acquire videos, pictures, and associated information, the user terminal 411 accesses the database 414 through the network 412 and acquires the information stored in the database 414 through the network 412. The embodiments of the present disclosure do not impose any limitation on the type of the database, for example, it may be a relational database or a non-relational database, etc.

At least one embodiment of the present disclosure further provides a page display apparatus, the page display apparatus may display the page overlay about the target object on the media display page, such as a live streaming page, to display detailed information about the target object in the form of an overlay, and the problem of video interruption due to page jumps in the related technologies may be avoided. Moreover, based on the page display apparatus, the size of the page overlay and the associated information displayed may be changed by a touch operation, which may make the display form of the detailed information more novel and diversified, and enhance the interactive experience.

FIG. 7 illustrates a schematic block diagram of a page display apparatus provided by some embodiments of the present disclosure. As shown in FIG. 7, the page display apparatus 500 includes a first display module 510 and a second display module 520. For example, the page display apparatus 500 may be applied to a user terminal, or may be applied to any device or system requiring page display, and the embodiments of the present disclosure do not limit this.

The first display module 510 is configured to display a page overlay about a target object on a first media display page, the page overlay covers at least a portion of a predetermined page, and the page overlay includes an object display region for displaying the target object and an information display region for displaying first associated information about the target object. For example, the first display module 510 may perform the step S110 of the page display method as shown in FIG. 1.

The second display module 520 is configured to change the object display region of the page overlay from a first display size to a second display size in response to a first operation instruction for the page overlay. For example, the second display module 520 may perform the step S120 of the page display method as shown in FIG. 1.

For example, the first display module 510 and the second display module 520 may each be hardware, software, firmware, and any feasible combination thereof. For example, the first display module 510 and the second display module 520 may be specialized or general-purpose circuits, chips, or devices, etc., or may be a combination of a processor and a memory. With respect to the specific forms of implementation of the first display module 510 and the second display module 520, the embodiments of the present disclosure does not limit this.

It should be noted that in the embodiments of the present disclosure, the various modules of the page display apparatus 500 correspond to the various steps of the aforementioned page display method, and the specific functions of the page display apparatus 500 may be referred to the relevant descriptions of the page display method above, which are not repeated herein. The components and structure of the page display apparatus 500 shown in FIG. 7 are merely exemplary and not restrictive, and the page display apparatus 500 may include other components and structures as needed.

For example, in some examples, the second display module 520 is further configured to replace the first associated information in the information display region of the page overlay with the second associated information, during changing the object display region of the page overlay from the first display size to the second display size.

For example, in some examples, the second display module 520 is further configured to: gradually change the object display region of the page overlay from the first display size to the second display size; and visually gradually replace the first associated information in the information display region of the page overlay with the second associated information.

For example, in some examples, the page overlay further includes a control accommodation region for accommodating at least one page control. The second display module 520 is further configured to replace a first control in the control accommodation region of the page overlay with a second control, during changing the object display region of the page overlay from the first display size to the second display size, and the first control is different from the second control.

For example, in some examples, the second display module 520 is further configured to replace the first control visually gradually in the control accommodation region of the page overlay with the second control.

For example, in some examples, the first display size is smaller than the second display size.

For example, in some examples, the page overlay completely covers the first media display page if the object display region of the page overlay has the second display size.

For example, in some examples, the first media display page is a video play page, the object display region is configured to display a picture about the target object, and the video played on the video play page is a video corresponding to the target object.

For example, in some examples, if the object display region of the page overlay has the first display size, the object display region displays a portion of the image region of the picture about the target object.

For example, in some examples, if the object display region of the page overlay has the second display size, the object display region displays all the image region of the picture about the target object.

For example, in some examples, the first associated information includes first sub-associated information; if the object display region of the page overlay has the first display size, the information display region displays a part of the first sub-associated information; and if the object display region of the page overlay has the second display size, the information display region displays all the first sub-associated information.

For example, in some examples, the first operation instruction is generated by an interaction event.

For example, in some examples, the interaction event is a touch operation for the page overlay.

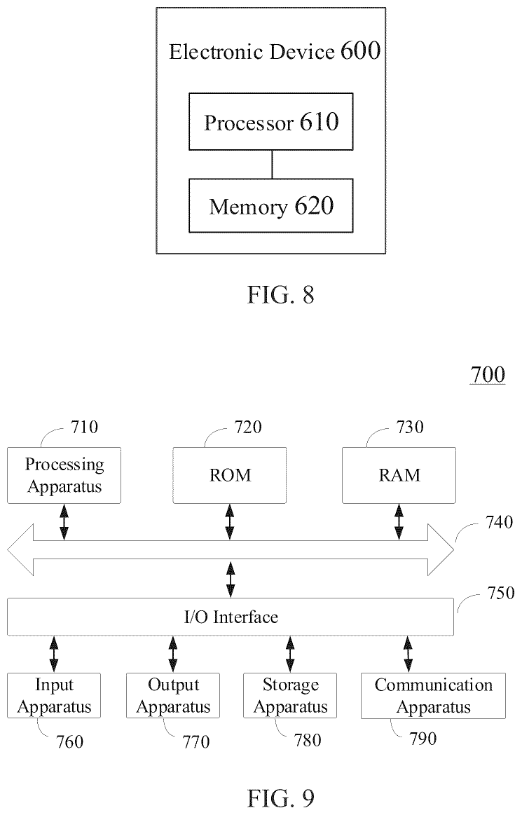

FIG. 8 illustrates a schematic block diagram of an electronic device provided by some embodiments of the present disclosure. As shown in FIG. 8, the electronic device 600 includes a processor 610 and a memory 620. The memory 620 is configured to non-transitorily store computer-readable instructions (e.g., one or more computer program modules). The processor 610 is configured to run the computer-readable instructions, and the computer-readable instructions, when run by the processor 610, may execute one or more steps in the page display method described above. The memory 620 and the processor 610 may be interconnected through a bus system and/or other forms of connection mechanisms (not shown).

For example, the processor 610 may be a Central Processing Unit (CPU), a Digital Signal Processor (DSP), or other form of processing unit having a data processing capability and/or a program execution capability, for example, a Field Programmable Gate Array (FPGA), etc.; for example, the Central Processing Unit (CPU) may be an X86, or ARM architecture, etc. The processor 610 may be a general-purpose processor or a special-purpose processor, and may control other components in the electronic device 600 to execute desired functions.

For example, the memory 620 may include any combination of one or more computer program products, and the computer program products may include various forms of computer readable storage media, for example, a volatile memory and/or a non-volatile memory. The volatile memory may include, for example, a Random Access Memory (RAM) and/or a cache, or the like. The non-volatile memory may include, for example, a Read-Only Memory (ROM), a hard disk, an Erasable Programmable Read Only Memory (EPROM), a portable Compact Disk Read-Only Memory (CD-ROM), a USB memory, a flash memory, or the like. One or more computer program modules may be stored on the computer readable storage medium, and the processor 610 may run the one or more computer program modules to implement various functions of the electronic device 600. Various applications and various data, as well as various data used and/or generated by the applications may also be stored on the computer readable storage medium.

It should be noted that in the embodiments of the present disclosure, the specific functions and technical effects of the electronic device 600 may be referenced from the description of the page display method mentioned above, and will not be repeated here.

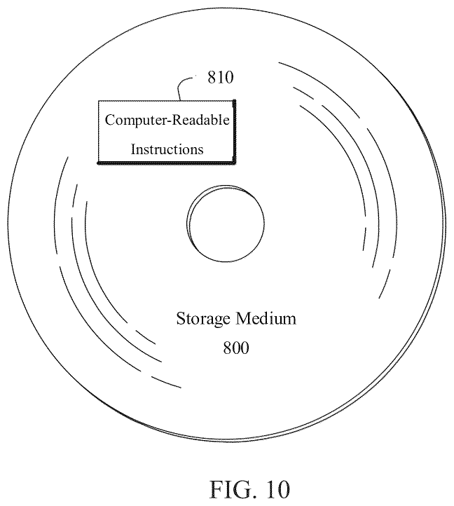

FIG. 9 is a schematic block diagram of another electronic device provided by some embodiments of the present disclosure. For example, the electronic device 700 is suitable for implementing the page display method provided by the embodiments of the present disclosure. The electronic device 700 may be a user terminal, etc. It should be noted that the electronic device 700 shown in FIG. 9 is just an example and does not impose any limitations on the functionality and scope of use of the embodiments of the present disclosure.

As illustrated in FIG. 9, the electronic device 700 may include a processing apparatus 710 (e.g., a central processing unit, a graphics processing unit, etc.), which can perform various suitable actions and processing according to a program stored in a read-only memory (ROM) 720 or a program loaded from a storage apparatus 780 into a random-access memory (RAM) 730. The RAM 730 further stores various programs and data required for operations of the electronic device 700. The processing apparatus 710, the ROM 720, and the RAM 730 are interconnected through a bus 740. An input/output (I/O) interface 750 is also connected to the bus 740.

Usually, the following apparatuses may be connected to the I/O interface 750: an input apparatus 760 including, for example, a touch screen, a touch pad, a keyboard, a mouse, a camera, a microphone, an accelerometer, a gyroscope, or the like; an output apparatus 770 including, for example, a liquid crystal display (LCD), a loudspeaker, a vibrator, or the like; a storage apparatus 780 including, for example, a magnetic tape, a hard disk, or the like; and a communication apparatus 790. The communication apparatus 790 may allow the electronic device 700 to be in wireless or wired communication with other devices to exchange data. While FIG. 9 illustrates the electronic device 700 having various apparatuses, it should be understood that not all of the illustrated apparatuses are necessarily implemented or included. The electronic device 700 may alternatively implement or include more or fewer apparatuses.

For example, according to the embodiments of the present disclosure, the page display method shown in FIG. 1 may be implemented as a computer software program. For example, the embodiments of the present disclosure include a computer program product, which includes a computer program carried by a non-transitory computer-readable medium. The computer program includes program code for performing the above-mentioned page display method. In such embodiments, the computer program may be downloaded online through the communication apparatus 790 and installed, or may be installed from the storage apparatus 780, or may be installed from the ROM 720. When the computer program is executed by the processing apparatus 710, the above-mentioned functions defined in the page display method provided by the embodiments of the present disclosure are performed.

At least one embodiment of the present disclosure further provides a storage medium, which is configured to non-transitorily store computer-readable instructions, and the computer-readable instructions, when executed by a computer, may implement the page display method described in any one of the embodiments of the present disclosure. By using the storage medium, the page overlay about the target object may be displayed on the media display page, such as a live streaming page, to display detailed information about the target object in the form of an overlay, and the problem of video interruption due to page jumps in the related technologies may be avoided. Moreover, based on the storage medium, the size of the page overlay may be changed by a touch operation, which may make the display form of the detailed information more novel and diversified, and enhance the interactive experience.

FIG. 10 illustrates a schematic diagram of a storage medium provided by some embodiments of the present disclosure. As shown in FIG. 10, the storage medium 800 is configured to non-transitorily store computer-readable instructions 810. For example, the computer-readable instructions 810, when executed by a computer, may implement one or more steps in the page display method according to the above description.

For example, the storage medium 800 may be applied in the electronic device 600 described above. For example, the storage medium 800 may be the memory 620 in the electronic device 600 shown in FIG. 8. For example, the related description of the storage medium 800 may be referred to the corresponding description of the memory 620 in the electronic device 600 shown in FIG. 8, which is not repeated here.

In the foregoing, the page display method, the page display apparatus, the electronic device, and the storage medium provided by the embodiments of the present disclosure are described in combination with FIG. 1 to FIG. 10.

The page display method provided by the embodiments of the present disclosure can display the page overlay about the target object on the media display page, such as a live streaming page, to display detailed information about the target object in the form of an overlay, and the problem of video interruption due to page jumps in the related technologies may be avoided. Moreover, based on the page display method, the size of the page overlay may be changed by a touch operation, which may make the display form of the detailed information more novel and diversified, and enhance the interactive experience.

It should be noted that the above-mentioned storage medium (computer-readable medium) in the present disclosure may be a computer-readable signal medium or a non-volatile computer-readable storage medium or any combination thereof. For example, the non-volatile computer-readable storage medium may be, but not limited to, an electric, magnetic, optical, electromagnetic, infrared, or semiconductor system, apparatus or device, or any combination thereof. More specific examples of the non-volatile computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the non-volatile computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program code. The data signal propagating in such a manner may take a plurality of forms, including but not limited to an electromagnetic signal, an optical signal, or any appropriate combination thereof. The computer-readable signal medium may also be any other computer-readable medium than the non-volatile computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementations, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to: display a page overlay about a target object on a first media display page, in which the page overlay covers at least a portion of a region of the first media display page, the page overlay includes an object display region for displaying the target object and an information display region for displaying first associated information about the target object, and the object display region has a first display size; and change the object display region of the page overlay from the first display size to a second display size in response to a first operation instruction for the page overlay.

The computer program code for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a standalone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the drawings illustrate the architecture, function, and operation of possible implementations of systems, methods, and computer program products according to various embodiments of the present disclosure. In this regard, each block in the flowcharts or block diagrams may represent a module, a program segment, or a portion of code, including one or more executable instructions for implementing specified logical functions. It should also be noted that, in some alternative implementations, the functions noted in the blocks may also occur out of the order noted in the drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

The above descriptions are merely some embodiments of the present disclosure and illustrations of the technical principles employed. Those skilled in the art should understand that the scope of disclosure involved in the present disclosure is not limited to the technical solutions formed by the specific combination of the above-mentioned technical features, and should also cover, without departing from the above-mentioned disclosed concept, other technical solutions formed by any combination of the above-mentioned technical features or their equivalents, such as technical solutions which are formed by replacing the above-mentioned technical features with the technical features disclosed in the present disclosure (but not limited to) with similar functions.

Additionally, although operations are depicted in a particular order, it should not be understood that these operations are required to be performed in a specific order as illustrated or in a sequential order. Under certain circumstances, multitasking and parallel processing may be advantageous. Likewise, although the above discussion includes several specific implementation details, these should not be interpreted as limitations on the scope of the present disclosure. Certain features that are described in the context of separate embodiments may also be implemented in combination in a single embodiment. Conversely, various features that are described in the context of a single embodiment may also be implemented in multiple embodiments separately or in any suitable sub-combinations.

Although the subject matter has been described in language specific to structural features and/or method logical actions, it should be understood that the subject matter defined in the appended claims is not necessarily limited to the specific features or actions described above. Rather, the specific features and actions described above are merely example forms of implementing the claims.

What is claimed is:

1. A page display method, comprising:
displaying a page overlay about a target object on a first media display page, wherein the page overlay covers at least a portion of a region of the first media display page, the page overlay comprises an object display region for displaying the target object and an information display region for displaying first associated information about the target object, and the object display region has a first display size; and
changing the object display region of the page overlay from the first display size to a second display size in response to a first operation instruction for the page overlay.

2. The page display method according to claim 1, further comprising:
replacing the first associated information in the information display region of the page overlay with second associated information, during changing the object display region of the page overlay from the first display size to the second display size.

3. The page display method according to claim 2, wherein the changing the object display region of the page overlay from the first display size to the second display size, comprises:
changing the object display region of the page overlay from the first display size to the second display size;
the replacing the first associated information in the information display region of the page overlay with the second associated information, comprises:
visually replacing the first associated information in the information display region of the page overlay with the second associated information.

4. The page display method according to claim 1, wherein the page overlay further comprises a control accommodation region for accommodating at least one page control, and
the page display method further comprises:
replacing a first control in the control accommodation region of the page overlay with a second control, during changing the object display region of the page overlay from the first display size to the second display size, wherein the first control is different from the second control.

5. The page display method according to claim 4, wherein the replacing the first control in the control accommodation region of the page overlay with the second control, comprises:
visually replacing the first control in the control accommodation region of the page overlay with the second control.

6. The page display method according to claim 3, wherein the first display size is smaller than the second display size.

7. The page display method according to claim 6, wherein the page overlay completely covers the first media display page if the object display region of the page overlay has the second display size.

8. The page display method according to claim 1, wherein the first media display page is a video play page, and the object display region is configured to display a picture about the target object; and
a video played on the video play page is a video corresponding to the target object.

9. The page display method according to claim 8, wherein if the object display region of the page overlay has the first display size, the object display region displays a portion of an image region of the picture about the target object.

10. The page display method according to claim 9, wherein if the object display region of the page overlay has the second display size, the object display region displays all the image region of the picture about the target object.

11. The page display method according to claim 1,
wherein the first associated information comprises first sub-associated information;
if the object display region of the page overlay has the first display size, the information display region displays a part of the first sub-associated information; and
if the object display region of the page overlay has the second display size, the information display region displays all the first sub-associated information.

12. A page display apparatus, comprising:
a first display module, configured to display a page overlay about a target object on a first media display page, wherein the page overlay covers at least a portion of a region of the first media display page, and the page overlay comprises an object display region for displaying the target object and an information display region for displaying first associated information about the target object; and
a second display module, configured to change the object display region of the page overlay from a first display size to a second display size in response to a first operation instruction for the page overlay.

13. An electronic device, comprising:
a processor; and
a memory, comprising one or more computer program modules,
wherein the one or more computer program modules are stored in the memory and configured to be executed by the processor, the one or more computer program modules comprise instructions for implementing a page display method, and the page display method comprises:
displaying a page overlay about a target object on a first media display page, wherein the page overlay covers at least a portion of a region of the first media display page, the page overlay comprises an object display region for displaying the target object and an information display region for displaying first associated information about the target object, and the object display region has a first display size; and
changing the object display region of the page overlay from the first display size to a second display size in response to a first operation instruction for the page overlay.

14. A computer-readable storage medium, configured to non-transitorily store computer-readable instructions,
wherein the computer-readable instructions, when executed by a computer, implement the page display method according to claim 1.

15. (canceled)

16. The page display method according to claim 2, wherein the page overlay further comprises a control accommodation region for accommodating at least one page control, and
the page display method further comprises:
replacing a first control in the control accommodation region of the page overlay with a second control, during changing the object display region of the page overlay from the first display size to the second display size, wherein the first control is different from the second control.

17. The page display method according to claim 3, wherein the page overlay further comprises a control accommodation region for accommodating at least one page control, and
the page display method further comprises:
replacing a first control in the control accommodation region of the page overlay with a second control, during changing the object display region of the page overlay from the first display size to the second display size, wherein the first control is different from the second control.

18. The page display method according to claim 2, wherein the first media display page is a video play page, and the object display region is configured to display a picture about the target object; and
a video played on the video play page is a video corresponding to the target object.

19. The page display method according to claim 18, wherein if the object display region of the page overlay has the first display size, the object display region displays a portion of an image region of the picture about the target object.

20. The page display method according to claim 3, wherein the first media display page is a video play page, and the object display region is configured to display a picture about the target object; and
a video played on the video play page is a video corresponding to the target object.

21. The page display method according to claim 20, wherein if the object display region of the page overlay has the first display size, the object display region displays a portion of an image region of the picture about the target object.
